(19) United States
(12) Patent Application Publication
(10) Pub. No.: US 2026/0136221 A1
(43) Pub. Date: May 14, 2026

(54) REPORTING-TRIGGERED MESSAGE OFFSET UPDATE

(71) Applicant: QUALCOMM Incorporated, San Diego, CA (US)

(72) Inventors: Diana MAAMARI, San Diego, CA (US); Gabi SARKIS, San Diego, CA (US); Jing JIANG, San Diego, CA (US)

(21) Appl. No.: 18/945,314

(22) Filed: Nov. 12, 2024

(51) Int. Cl. H04W 24/10; H04W 72/1268

(52) U.S. Cl. CPC H04W 24/10; H04W 72/1268

(57) ABSTRACT

Various aspects of the present disclosure generally relate to wireless communication. In some aspects, a user equipment (UE) may communicate, with a network node, a first set of one or more messages according to a minimum time offset between a control message and a data message. The UE may transmit a communication status report in association with one or more conditions, associated with communications at the UE, being satisfied. The UE may communicate, with the network node, a second set of one or more messages according to an updated minimum time offset in association with transmitting the communication status report. Numerous other aspects are described.

### FIELD OF THE DISCLOSURE

Aspects of the present disclosure generally relate to wireless communication and specifically relate to techniques, apparatuses, and methods associated with reporting-triggered message offset update.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a user equipment (UE). The apparatus may include one or more memories and one or more processors coupled to the one or more memories. The one or more processors may be configured to communicate, with a network node, a first set of one or more messages according to a minimum time offset between a control message and a data message. The one or more processors may be configured to transmit a communication status report in association with one or more conditions, associated with communications at the UE, being satisfied. The one or more processors may be configured to communicate, with the network node, a second set of one or more messages according to an updated minimum time offset in association with transmitting the communication status report.

Some aspects described herein relate to an apparatus for wireless communication at a network node. The apparatus may include one or more memories and one or more processors coupled to the one or more memories. The one or more processors may be configured to communicate, with a UE, a first set of one or more messages according to a minimum time offset between a control message and a data message. The one or more processors may be configured to receive a communication status report indicating that one or more conditions, associated with communications at the UE, are satisfied. The one or more processors may be configured to communicate, with the UE, a second set of one or more messages according to an updated minimum time offset in association with transmitting the communication status report.

Some aspects described herein relate to a method of wireless communication performed by a UE. The method may include communicating, with a network node, a first set of one or more messages according to a minimum time offset between a control message and a data message. The method may include transmitting a communication status report in association with one or more conditions, associated with communications at the UE, being satisfied. The method may include communicating, with the network node, a second set of one or more messages according to an updated minimum time offset in association with transmitting the communication status report.

Some aspects described herein relate to a method of wireless communication performed by a network node. The method may include communicating, with a UE, a first set of one or more messages according to a minimum time offset between a control message and a data message. The method may include receiving a communication status report indicating that one or more conditions, associated with communications at the UE, are satisfied. The method may include communicating, with the UE, a second set of one or more messages according to an updated minimum time offset in association with transmitting the communication status report.

Some aspects described herein relate to a non-transitory computer-readable medium that stores a set of instructions for wireless communication by a UE. The set of instructions, when executed by one or more processors of the UE, may cause the UE to communicate, with a network node, a first set of one or more messages according to a minimum time offset between a control message and a data message. The set of instructions, when executed by one or more processors of the UE, may cause the UE to transmit a communication status report in association with one or more conditions, associated with communications at the UE, being satisfied. The set of instructions, when executed by one or more processors of the UE, may cause the UE to communicate, with the network node, a second set of one or more messages according to an updated minimum time offset in association with transmitting the communication status report.

Some aspects described herein relate to a non-transitory computer-readable medium that stores a set of instructions for wireless communication by a network node. The set of instructions, when executed by one or more processors of the network node, may cause the network node to communicate, with a UE, a first set of one or more messages according to a minimum time offset between a control message and a data message. The set of instructions, when executed by one or more processors of the network node, may cause the network node to receive a communication status report indicating that one or more conditions, associated with communications at the UE, are satisfied. The set of instructions, when executed by one or more processors of the network node, may cause the network node to communicate, with the UE, a second set of one or more messages according to an updated minimum time offset in association with transmitting the communication status report.

Some aspects described herein relate to an apparatus for wireless communication. The apparatus may include means for communicating, with a network node, a first set of one or more messages according to a minimum time offset between a control message and a data message. The apparatus may include means for transmitting a communication status report in association with one or more conditions, associated with communications at the apparatus, being satisfied. The apparatus may include means for communicating, with the network node, a second set of one or more messages according to an updated minimum time offset in association with transmitting the communication status report.

Some aspects described herein relate to an apparatus for wireless communication. The apparatus may include means for communicating, with a UE, a first set of one or more messages according to a minimum time offset between a control message and a data message. The apparatus may include means for receiving a communication status report indicating that one or more conditions, associated with communications at the UE, are satisfied. The apparatus may include means for communicating, with the UE, a second set of one or more messages according to an updated minimum time offset in association with transmitting the communication status report.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4A is a diagram illustrating an example of a timing for delay status reporting, in accordance with the present disclosure.

FIG. 4B is a diagram illustrating examples of delay status reporting and delay statistics reporting, in accordance with the present disclosure.

FIG. 5A is a diagram illustrating an example of minimum scheduling offsets, in accordance with the present disclosure.

FIG. 5B is a diagram illustrating an example of a scheduling and decoding timeline associated with minimum scheduling offsets, in accordance with the present disclosure.

FIG. 6 is a diagram of an example associated with communication status reporting-triggered message scheduling offset switching, in accordance with the present disclosure.

FIG. 7 is a diagram illustrating an example associated with updating a minimum scheduling offset in association with channel conditions and/or latency considerations, in accordance with the present disclosure.

FIG. 8 is a diagram illustrating an example process performed, for example, at a UE or an apparatus of a user equipment (UE), in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may receive data, for transmission, at a buffer of the UE, such as when data is generated by an application of the UE. The UE may periodically transmit a buffer status report (BSR) to indicate an amount of data that is present at the buffer of the UE, among other information. The UE may report a total buffer size of each logical channel group (LCG) to a network node in a BSR medium access control (MAC) control element (MAC-CE). For example, a UE may transmit a BSR to a network node to indicate to the network node that the UE has uplink data to be transmitted. A BSR carries information that indicates how much data is in a buffer of the UE. The BSR may also indicate an LCG corresponding to the uplink data. An LCG is a combination of logical channels (LCHs) for which the UE reports and aggregates buffer status. For example, a UE may be configured with multiple LCGs that are used for transmitting different types of traffic (e.g., voice data, video data, control signaling, or the like). A network node may, in response to receiving the BSR, transmit an uplink grant to the UE. For example, the uplink grant may allocate one or more resources (e.g., time and/or frequency resources) for transmission of the uplink data.

A delay status report (DSR) may indicate a total number of bytes of uplink traffic that is below a delay threshold configured by the network node. The DSR may assist the network node to adjust a scheduling pattern to ensure that data is transmitted within delay requirements to satisfy the QoS requirements or adapt other characteristics (e.g., codec rate) in an end-to-end (E2E) system. A padding DSR may indicate a total buffer remaining with each LCG below a delay threshold to accommodate for all of the LCGs within a lowest delay threshold within the remaining bits in the MAC TB.

In some aspects, “minimum time offset,” “minimum scheduling offset,” “minimum data message offset,” and/or “message offset” may be used interchangeably to refer to a quantity of time resources between reception of a control message at a UE and the resource in which a data message is scheduled.

A UE and a network node may communicate according to one or more timing and/or scheduling offsets. For example, uplink and/or downlink data messages may be scheduled via a downlink control message. A network node may transmit a downlink control message (e.g., downlink control information (DCI), a physical downlink control channel (PDCCH) message) that indicates a minimum offset for the communication of an uplink data message (e.g., a physical uplink shared channel (PUSCH) message, and/or a physical downlink shared channel (PDSCH) message). A first type of minimum scheduling offset, k0, may refer to a minimum gap in time resources between a PDCCH and a PDSCH that is scheduled by the PDCCH. For example, when k0=0, the PDCCH message and the PDSCH message may be transmitted during a same time resource; when k0=1, the PDCCH message may be transmitted in a first time resource, n and the PDSCH message may be communicated during a second time resource, n+1, and so on. A second type of minimum scheduling offset, k2, may refer to a minimum gap in time resources between a PDCCH and a PUSCH that is scheduled by the PDCCH. For example, when k2=0, the PDCCH message and the PUSCH message may

be communicated during a same time resource; when k0=1, the PDCCH message may be transmitted in a first time resource, n, and the PUSCH message may be transmitted during a second time resource, n+1, and so on. For each of k0 and k2, the absolute minimum value is 0. In some aspects, k0 and/or k2 may refer to a minimum guaranteed time offset, and the scheduled data message may be communicated during a time resource that is equal to or greater than the offset.

The minimum guaranteed scheduling offset value may have a significant impact on UE power consumption and/or latency. When the minimum scheduling offset is equal to the absolute minimum scheduling offset, the UE may buffer data for an entire frequency bandwidth, and not just the data associated with the PDCCH, for example, in case the PDCCH message schedules a PDSCH message in the same slot. For example, when k0 is equal to the absolute minimum, the UE may prepare to receive a PDSCH in the same slot each time it receives a PDCCH, which may consume excessive resources in a case where a PDCCH is transmitted at a time resource offset greater than the absolute minimum time offset. For example, the UE may decode DCI associated with the PDCCH relatively quickly to meet a minimum PDSCH feedback timeline. This may increase UE power consumption. When k0 is equal to the absolute minimum, the time available to decode a PDSCH message and prepare a physical uplink control channel (PUCCH) message may be decreased, thereby further increasing UE power consumption. When k0 is equal to the absolute minimum, the UE may be prevented, in some scenarios, from powering off radio frequency via non-scheduling carriers in the example of cross-carrier scheduling. However, when k0 is equal to the absolute minimum, communications between the UE and the network node may be associated with low latency and may be able to more easily satisfy low latency specification requirements and/or quality of service (QoS) requirements.

In another example, when k2 is equal to the absolute minimum, the UE may prepare to transmit PUSCH in the same slot each time the UE receives a PDCCH, which may consume excessive resources in a case where the PDCCH schedules the PUSCH during a time resource that is offset from the PDCCH by a quantity of time resources that is greater than the absolute minimum time offset. For example, the UE may decode DCI associated with the PDCCH relatively quickly to meet a minimum PDSCH feedback timeline and prepare PUSCH. This may increase UE power consumption. When k2 is equal to the absolute minimum, the time available to decode PDSCH and buffer PUSCH data may be decreased, thereby further increasing UE power consumption. When k2 is equal to the absolute minimum, the UE may also be prevented, in some scenarios, from powering off radio frequency via non-scheduling carriers in the example of cross-carrier scheduling. Minimum values for k0/k2 may be configured per bandwidth part (BWP). In such examples, DCI may indicate which minimum scheduling offset value is in effect. However, this feature may rely on explicit signaling from the network node every time the minimum scheduling offset is to be changed. Thus, by using only one minimum scheduling offset value and/or consuming overhead resources to switch minimum scheduling offsets, the UE 120 may lose potential latency gains and/or power saving benefits.

Various aspects relate generally to reporting-triggered message offset update. Some aspects more specifically relate to BSR, DSR, and/or scheduling request-triggered message scheduling offset switching. For example, various aspects relate to how a UE can change a minimum scheduling offset to balance power saving with reduced latency without significantly increasing network overhead. Some aspects more specifically relate to updating a minimum scheduling offset in association with channel conditions and/or latency considerations indicated by BSR, DSR, and/or scheduling request transmissions. In some aspects, the UE may communicate, with a network node, a first set of one or more messages according to a minimum time offset (e.g., k0, k2) between a control message (e.g., PDCCH, DCI) and a data message (e.g., PDSCH, PUSCH). In some aspects, the UE may transmit a communication status report (e.g., BSR, DSR, scheduling request) in association with one or more conditions, associated with communications at the UE, being satisfied. In some aspects, the UE may communicate, with the network node, a second set of one or more messages according to an updated minimum time offset (e.g., updated k0, updated k2) in association with transmitting the communication status report.

In some aspects, the UE may receive, at a first time from the network node, an additional control message that schedules resources for an uplink data message, and may transmit, at a second time, the uplink data message, where the second time is offset from the first time by at least the updated minimum time offset. In some other aspects, the UE may receive, during a first time resource from the network node, an additional control message that schedules resources for a downlink control message, and may receive, during a second time resource, the downlink control message, where the second time resource is offset from the first time resource by at least the updated minimum time offset. In some aspects, the UE may transmit, to the network node, an indication of the updated minimum time offset. In some aspects, communicating the second set of one or more messages according to the updated minimum time offset may include communicating the second set of one or more messages after an applicability delay that is initiated by the UE transmitting the communication status report.

Particular aspects of the subject matter described in this disclosure can be implemented to realize one or more of the following potential advantages. In some examples, the described techniques can be used to conserve power expenditure in scenarios where latency is a lower priority than power conservation, and decrease latency in scenarios where power consumption is a lower priority than latency. For example, by communicating, with a network node, according to the minimum time offset, the UE may conserve power by transmitting messages using a relatively larger minimum time offset. By the UE transmitting a communication status report (e.g., BSR, DSR, scheduling request) in association with one or more conditions, associated with communications at the UE, being satisfied, the UE may signify that low latency communications have or are becoming a priority, which may prompt the network node to take one or more actions to prioritize low latency communications. By communicating according to the updated minimum time offset, the UE may reduce latency of communications with the network node. By waiting to transmit the communication status report to switch to communicating according to the updated minimum scheduling offset, the UE may conserve power expenditure for communications in which latency is a higher priority and may conserve power for communications in which latency is a lower priority.

For example, by the UE receiving, at a first time from the network node, the additional control message that schedules resources for the uplink data message, and transmitting and/or receiving, at a second time, the uplink data message, where the second time is offset from the first time by at least the updated minimum time offset and the second time offset is smaller than the first time offset, the UE may satisfy latency requirements. By the UE transmitting the indication of the updated minimum time offset, the UE may decrease an amount of time the network node uses to switch to communicating according to the updated minimum scheduling offset. By communicating the second set of one or more messages after the applicability delay, the network node may have enough time to decode a control message (e.g., MAC-CE indicating the updated minimum scheduling offset) before applying the second minimum scheduling offset, reducing the likelihood of an error associated with communicating the data message.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

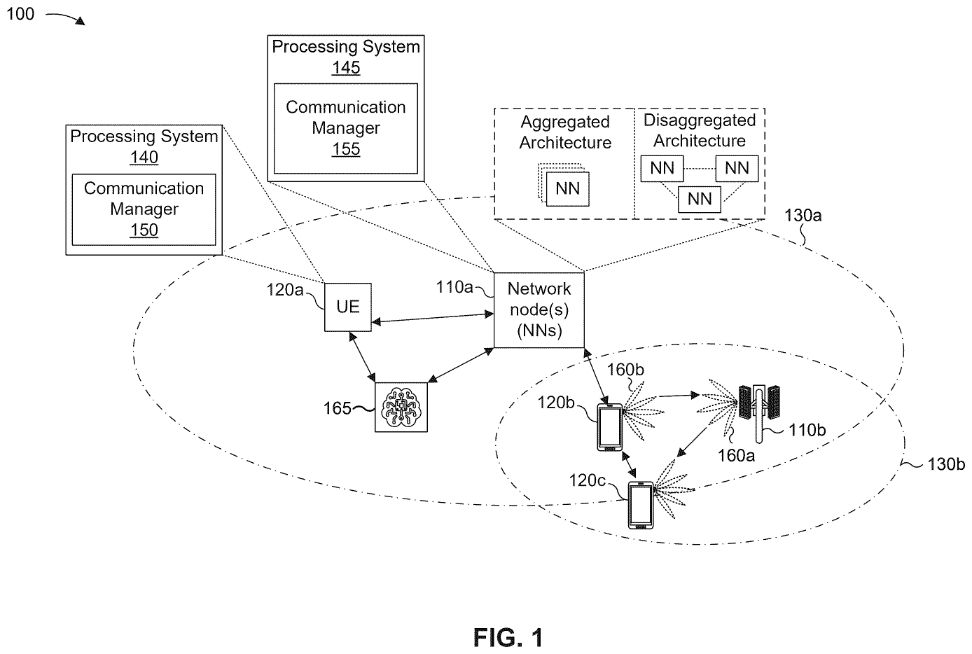

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub- 6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

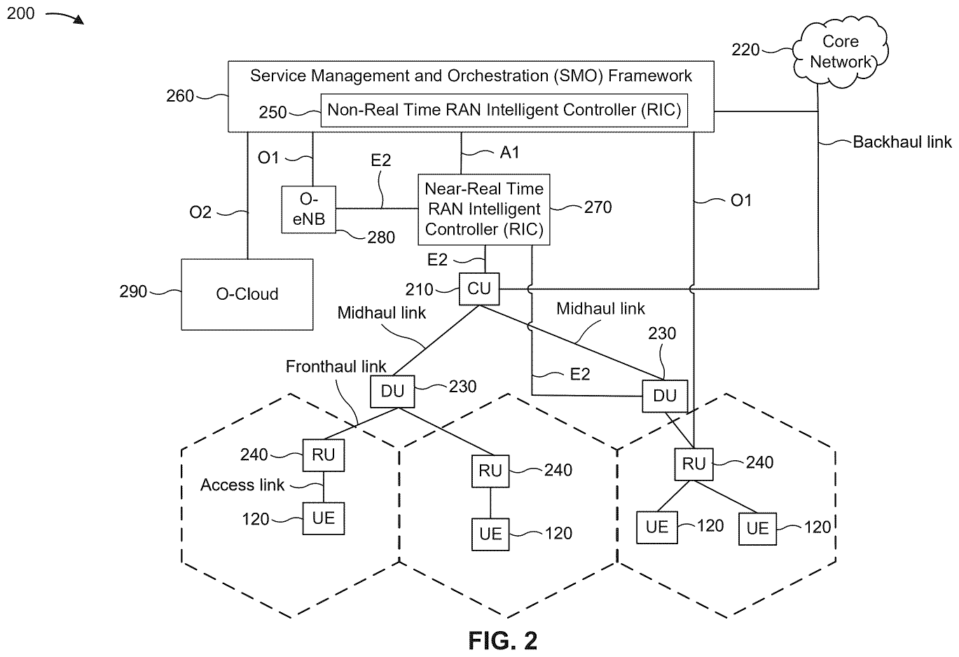

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify resource blocks in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may communicate, with a network node, a first set of one or more messages according to a minimum time offset between a control message and a data message; transmit a communication status report in association with one or more conditions, associated with communications at the UE, being satisfied; and communicate, with the network node, a second set of one or more messages according to an updated minimum time offset in association with transmitting the communication status report. Additionally, or alternatively, the communication manager 150 may perform one or more other operations described herein.

In some aspects, the network node 110 may include a communication manager 155. As described in more detail elsewhere herein, the communication manager 155 may communicate, with a UE, a first set of one or more messages according to a minimum time offset between a control message and a data message; receive a communication status report indicating that one or more conditions, associated with communications at the UE, are satisfied; and communicate, with the UE, a second set of one or more messages according to an updated minimum time offset in association with transmitting the communication status report. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

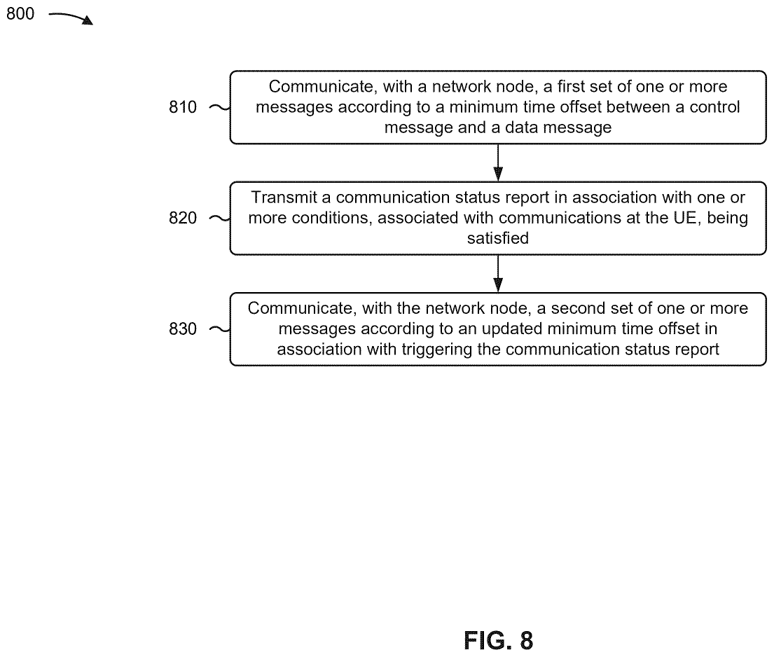

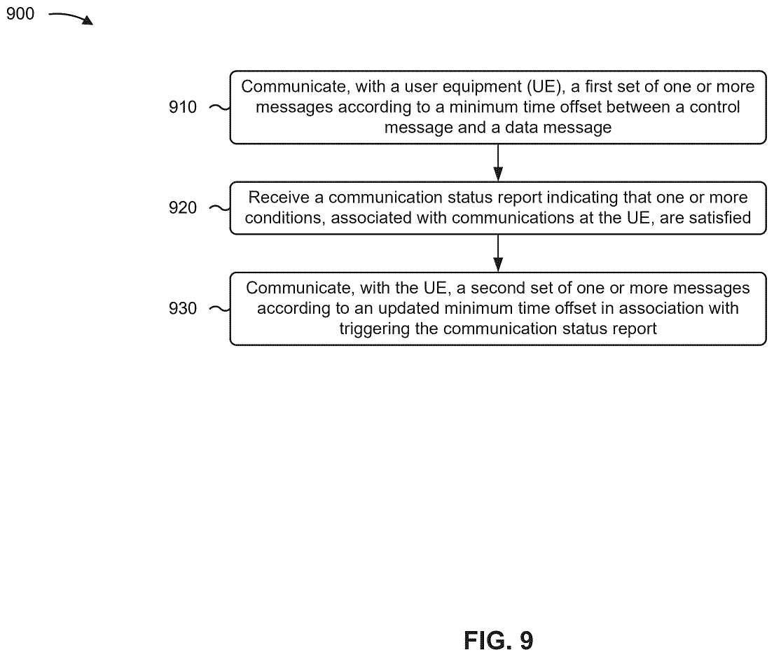

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with updating a minimum scheduling offset in association with channel conditions, power consumption considerations, and/or latency considerations, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

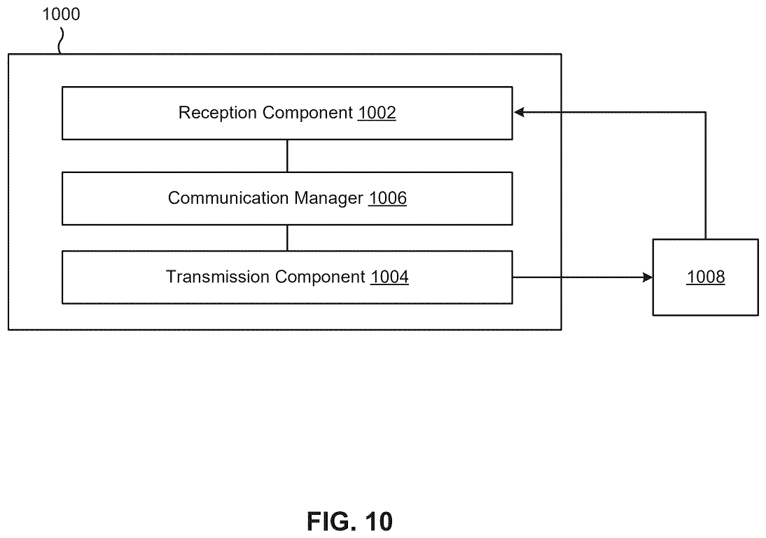

In some aspects, the UE 120 includes means for communicating, with a network node, a first set of one or more messages according to a minimum time offset between a control message and a data message; means for transmitting a communication status report in association with one or more conditions, associated with communications at the UE 120, being satisfied; and/or means for communicating, with the network node, a second set of one or more messages according to an updated minimum time offset in association with transmitting the communication status report. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

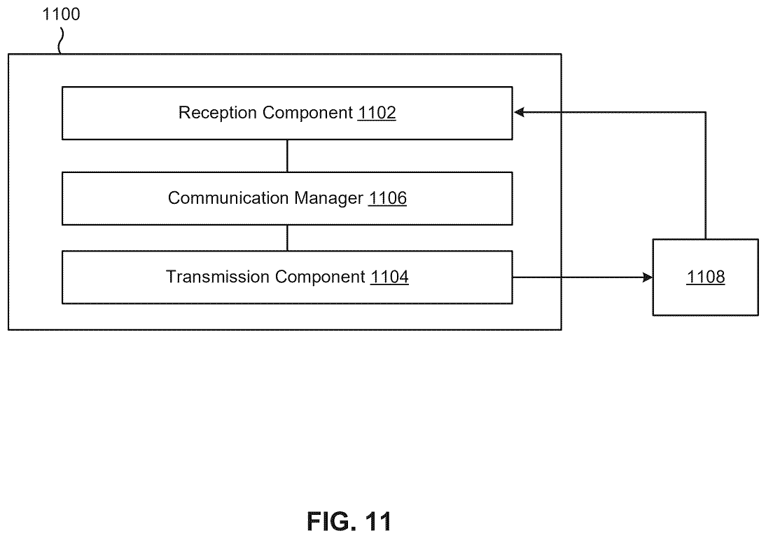

In some aspects, the network node 110 includes means for communicating, with a UE 120, a first set of one or more messages according to a minimum time offset between a control message and a data message; means for receiving a communication status report indicating that one or more conditions, associated with communications at the UE 120, are satisfied; and/or means for communicating, with the UE 120, a second set of one or more messages according to an updated minimum time offset in association with transmitting the communication status report. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

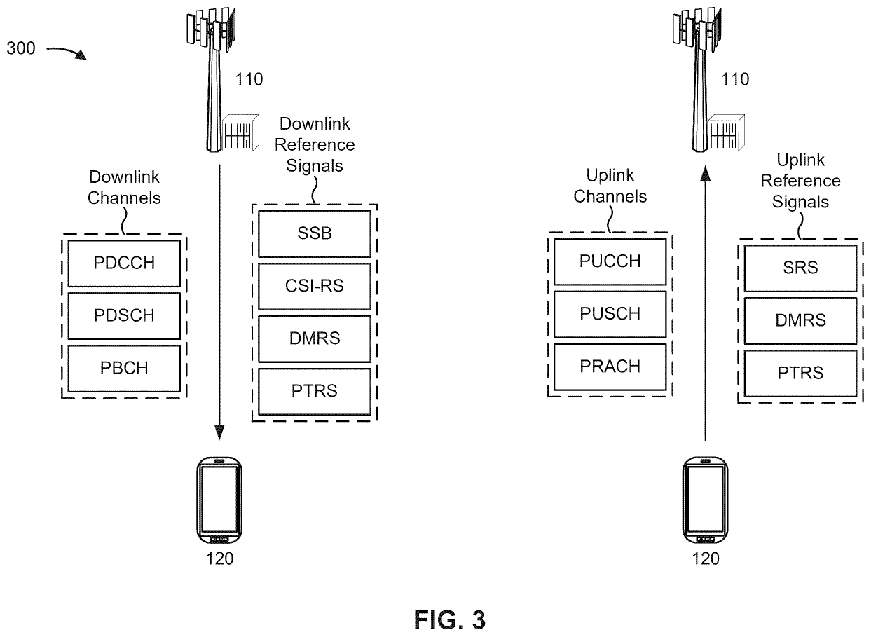

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

The UE 120 and a network node 110 may communicate according to one or more timing and/or scheduling offsets. For example, uplink and/or downlink data messages may be scheduled via a downlink control message. The network node 110 may transmit a downlink control message (e.g., DCI, a PDCCH message) that indicates a minimum offset for the communication of an uplink data message (e.g., a PUSCH message, and/or a PDSCH message). A first type of minimum scheduling offset, k0, may refer to a minimum gap in time resources between a PDCCH and a PDSCH that is scheduled by the PDCCH. For example, when k0=0, the PDCCH message and the PDSCH message may be transmitted during a same time resource; when k0=1, the PDCCH message may be transmitted in a first time resource, n, and the PDSCH message may be communicated during a second time resource, n+1, and so on. A second type of minimum scheduling offset, k2, may refer to a minimum gap in time resources between a PDCCH and a PUSCH that is scheduled by the PDCCH. For example, when k2=0, the PDCCH message and the PUSCH message may be communicated during a same time resource; when k0=1, the PDCCH message may be transmitted in a first time resource, n, and the PUSCH message may be transmitted during a second time resource, n+1, and so on. For each of k0 and k2, the absolute minimum value is 0. In some aspects, k0 and/or k2 may refer to a minimum guaranteed time offset, and the scheduled data message may be communicated during a time resource that is equal to or greater than the offset.

The minimum guaranteed scheduling offset value may have a significant impact on UE power consumption and/or latency. For example, each minimum guaranteed scheduling offset value may be associated with different power consumption benefits and/or latency benefits. By communicating according to a single minimum scheduling offset value and/or consuming overhead resources to switch minimum scheduling offsets, the UE 120 may lose out on potential latency gains and/or power saving benefits.

As indicated above, FIG. 3 is provided as an example. Other examples may differ from what is described with regard to FIG. 3.

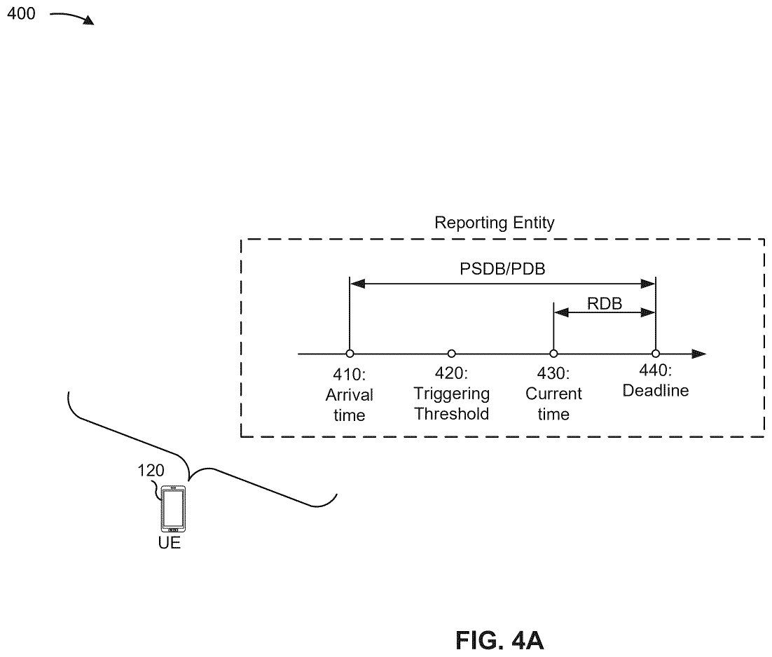

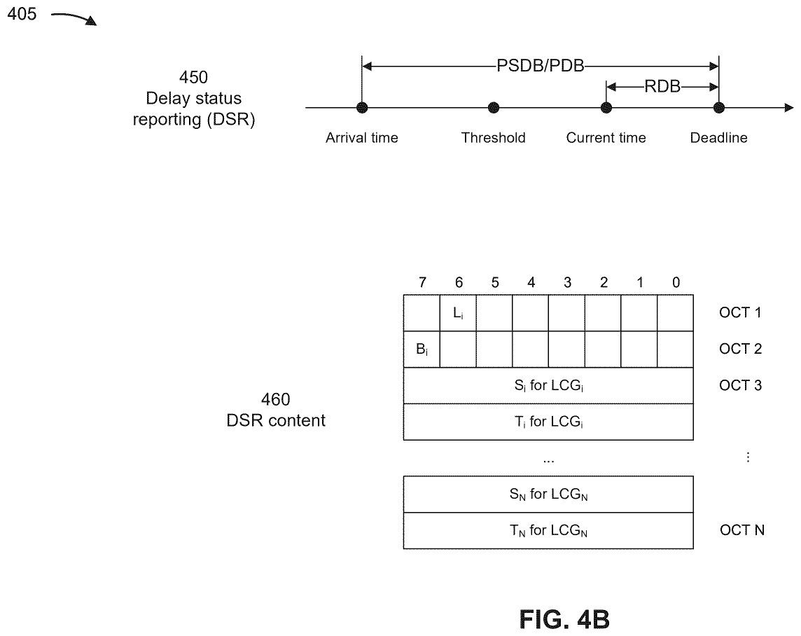

FIG. 4A is a diagram illustrating an example 400 of a timing for delay status reporting, in accordance with the present disclosure.

As shown in FIG. 4A, a reporting entity may be configurable with a timeline for transmitting a DSR, which may also be referred to as “delay information reporting” (DIR). The reporting entity may be an entity for which a UE 120 reports delay information in a DSR. For example, the reporting entity may be a data radio bearer (DRB), a LCH, or a set of logical channels (e.g., a LCG). In some examples, a DRB may include a plurality of LCHs corresponding to a plurality of protocol data unit (PDU) sets, each including one or more PDUs with a common parameter (e.g., an importance level parameter). A UE 120 may be configured with a plurality of reporting entities, in some examples.

As further shown in FIG. 4A, the timeline for delay status reporting may be based at least in part on an arrival time 410. The arrival time 410 may include a time at which a first PDU of a PDU set is received by the UE 120. In some examples, the first received PDU may be different than a first indexed PDU (e.g., as a result of out of order delivery of PDUs). An amount of remaining time for a PDU may be associated with a PDU set delay budget (PSDB) or a packet delay budget (PDB). For example, the UE 120 (or the reporting entity thereof) may be configured with a PSDB timer, which represents an amount of time after the arrival time 410 during which a PDU set can be delivered from the UE 120 to a destination device (e.g., a network node (not shown)). Similarly, the UE 120 may be configured with a PDB timer, which represents an amount of time after the arrival time 410 during which a PDU (e.g., which is not associated with a PDU set) can be delivered from the UE 120 to a destination device (e.g., before a failure occurs).

The UE 120 may be configured with a time threshold 420 (T_{DIR,m}) for a reporting entity m. The time threshold 420 may be configured as an absolute time or a percentage of time between the arrival time 410 and an end of the PSDB or PDB, such as deadline 440. The remaining delay budget (RDB) may indicate a time between a current time 430 and the deadline 440 and/or the end of the PSDB or PDB.

FIG. 4B is a diagram illustrating examples 405 of delay status reporting and delay statistics reporting, in accordance with the present disclosure. More particularly, as described herein, delay status reporting and/or delay statistics reporting (sometimes referred to as statistical delay reporting) may be useful to schedule delay-sensitive traffic, such as XR traffic, more efficiently than using a PSDB or a PDB. For example, as shown by reference number 450 in FIG. 4B, a delay budget (e.g., a PSDB or PDB) generally starts when a PDU or a PDU set arrives in an uplink buffer associated with a UE, rather than when a network node is informed about the existence of a PDU from a BSR that the UE transmits to indicate how much uplink data is in the uplink buffer. Accordingly, the PSDB/PDB may be insufficient to schedule XR or other delay-sensitive traffic efficiently, because the network node is unable to know the RDB for buffered uplink data (e.g., because the BSR does not indicate how much data is buffered for how long). As a result, the network node is unable to determine when the delay budget associated with a buffered PDU will deplete, whereby a PSDB/PDB alone cannot adequately enable enhanced scheduling for delay-sensitive traffic. Accordingly, because the RDB (rather than the PSDB/PDB) indicates how soon a network node needs to provide uplink grants, the network node may configure a UE to dynamically report an RDB associated with a PDU stored in a Layer 2(L 2 ) buffer associated with the UE, where the RDB may be defined as a difference between a PDB or PSDB of a QoS flow associated with the PDU and the time that has elapsed since the PDU was received at a service data adaptation protocol (SDAP) layer. In this way, the network node may know the RDB for buffered uplink data and issue uplink grants before the deadline associated with the buffered uplink data.

In some aspects, as described herein, one or more triggers may be defined (e.g., in a wireless communication standard) and/or configured (e.g., by the network node) to define when a UE is to transmit a DSR to the network node. For example, in some aspects, the network node may generally configure one or more LCGs for which the UE is to provide a DSR, where each LCG may include one or more LCHs. For example, the UE may be configured with multiple LCHs, and may have data associated with one or more LCHs available for transmission at a time when the UE has an allocation of uplink resources. The UE may use an LCH prioritization configuration (LCP) procedure that controls how uplink shared channel resources are shared among the LCHs. In general, transmission of a DSR may be event-triggered or timer-triggered, which may be configured per LCG. For example, in an event-triggered DSR, the network node may configure a reporting threshold related to an RDB for an associated LCG, and a DSR may be triggered (e.g., the UE may transmit a DSR for the associated LCG) based on a minimum RDB among all PDUs in the associated LCG failing to satisfy (e.g., failing to equal or exceed) the reporting threshold. Additionally, or alternatively, in a timer-triggered DSR, the network node may configure a periodic DSR timer for an LCG, and a DSR may be triggered based on the periodic DSR timer expiring. In general, a triggered DSR (e.g., an event-triggered or timer-triggered DSR) may remain pending until an associated DSR MAC-CE is included in a physical uplink shared channel (PUSCH) transmission, and a pending DSR may trigger a scheduling request until the pending DSR has been cancelled.

For example, as further shown in FIG. 4B, reference number 460 depicts an example format for the content of a DSR MAC-CE. For example, the DSR MAC-CE may include one or more octets providing a bitmap to indicate which LCGs the UE is reporting in the DSR MAC-CE, where each LCG is associated with a first octet that indicates an amount of data in the reported LCG at a sampling instance, Sᵢ, which may encoded using legacy or new BSR tables, and a duration between the sampling instance and a transmission time of the DSR in a PUSCH, Tᵢ, which may be indicated in a unit of slots (e.g., with a maximum of 32 ms×8 slots/ms). In some aspects, the sampling instance may correspond to a slot in which the DSR was triggered or a slot in which the MAC PDU containing the DSR is assembled.

Additionally, or alternatively, a network node may configure a UE to measure and report downlink and/or uplink delay statistics for one or more DRBs that are used to transport the delay-sensitive traffic. For example, in some cases (e.g., where a traffic flow has a varying frame rate), a UE may be unable to signal nominal arrival times and delivery deadlines for each PDU or PDU set. In such cases, the network node has to schedule the one or more DRBs using a fixed delay budget, which can result in conservative deadlines. Accordingly, in some aspects, the network node may configure the UE to provide feedback on delay statistics (e.g., an average delay, a standard deviation, or the like) such that the network node can adapt the delay budgets that are configured and/or applied to compensate for scheduling inefficiencies. For example, on a downlink, the UE can be configured to measure the amount of delay budget that is remaining before a delivery deadline (e.g., a residual delay budget) for a PDU or a PDU set and to report the residual delay budget to the network node. The network node can then use the residual delay budget reported by the UE to adjust the delay budget that the network node applies to downlink traffic (e.g., the network node may increase the delay budget applied to downlink traffic if the residual delay budget is large). Additionally, or alternatively, on an uplink, the UE can be configured to measure and report the amount of delay that a PDU or a PDU set experienced when successfully received by the network node (e.g., upon reception of a positive RLC status report). The network node can then use the reported delay statistics to estimate the residual delay budget for the rest of the connection (e.g., by subtracting the delay reported by the UE from an end-to-end delay budget that is provisioned for a flow).

In some aspects, in cases where the UE is configured to report statistical delay information, the UE may generally report first order statistics and/or second order statistics for delays associated with one or more MAC PDUs from LCHs that are configured for statistical delay reporting. In some aspects, the delay statistics may be measured for both downlink and uplink traffic. For example, on the downlink, the delay statistics may include a delay from a first time when a physical downlink control channel (PDCCH) for a transport block is received to a second time when data associated with the transport block is delivered to an application. Additionally, or alternatively, on the uplink, the delay statistics may indicate a maximum delay from a first time when data is generated by an application to a second time when a transport block is transmitted in a PUSCH. In addition, the UE may measure a residual delay budget on the downlink, which refers to the time difference between the end of a delay budget configured by the network node and a delivery deadline that is required by an application. For example, in some aspects, the downlink and/or uplink delay statistics may include a mean, a variance, a standard deviation, and/or other statistics related to the delay measured on downlink and/or uplink traffic over a configured averaging window. Furthermore, in some aspects, the delay statistics may include buffer information. The delay statistics may be transmitted by a UE in a MAC-CE when the UE has a PUSCH resource available for transmission of the delay statistics. In some aspects, the delay statistics may include a statistical delay for multiple LCHs that are configured for delay status reporting, and a trigger for transmission of the delay statistics can be based on statistical thresholds compared to one or more statistical parameters having smallest values or a smallest RDB.

In some examples, DSR may be transmitted to inform the network node of a delay status of LCGs. For example, without an uplink UL report including the delay status of LCGs, the network node may not have information associated with the uplink delay and how different the uplink delay is from the nominal PDB. The delay for an LCG may include a remaining time that is the smallest remaining value of one or more PDCP discard timers. In some examples, a remaining time threshold may be configured via RRC signaling and may include a remaining time threshold for triggering a DSR for an LCG. A DSR may be triggered if the smallest remaining value of the PDCP discard timers for buffered data (e.g., all data buffered for the LCG but that has not been transmitted in any MAC PDU) falls below a remaining time threshold, such as remainingTimeThreshold, for the LCG. Thus, the triggering of a DSR may signify that latency is a priority for subsequent communications. The triggering of a BSR may similarly signify that latency is a priority for subsequent communications.

As indicated above, FIGS. 4A and 4B are provided as examples. Other examples may differ from what is described with respect to FIGS. 4A and 4B.

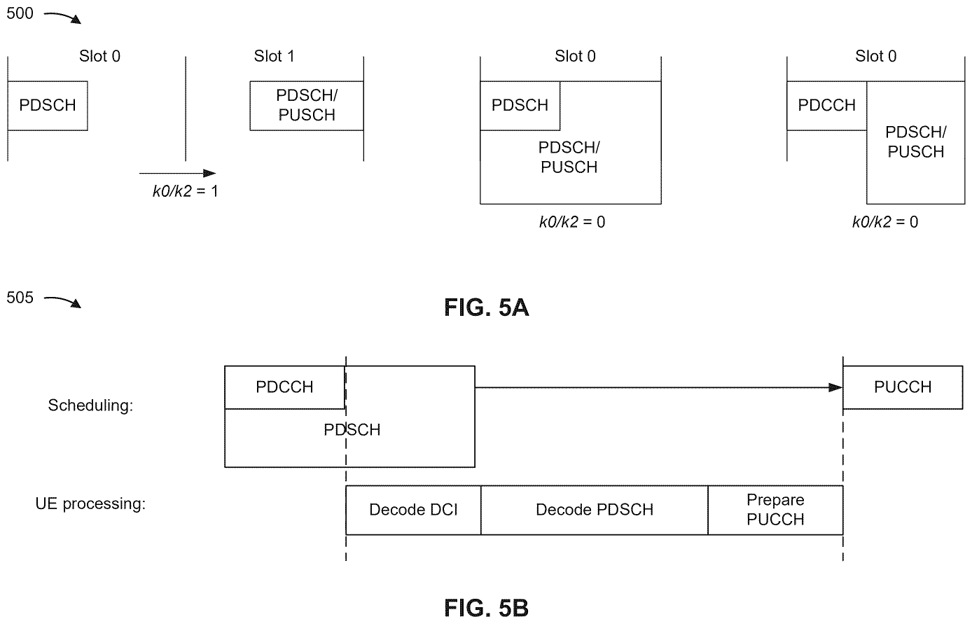

FIG. 5A is a diagram illustrating an example 500 of minimum scheduling offsets, in accordance with the present disclosure.

A UE and a network node may communicate according to one or more timing and/or scheduling offsets. For example, PUSCH and/or PDSCH messages may be scheduled via a PDSCH message. The network node may transmit a PDCCH message according to a minimum scheduling offset for the communication of a PUSCH message, and/or a PDSCH message. A first type of minimum scheduling offset, k0, may refer to a minimum gap in time resources between a PDCCH and a PDSCH that is scheduled by the PDCCH. For example, when k0=0, the PDCCH message and the PDSCH message may be transmitted during a same time resource; when k0=1, the PDCCH message may be transmitted in a first time resource, n, and the PDSCH message may be communicated during a second time resource, n+1, and so on. A second type of minimum scheduling offset, k2, may refer to a minimum gap in time resources between a PDCCH and a PUSCH that is scheduled by the PDCCH. For example, when k2=0, the PDCCH message and the PUSCH message may be communicated during a same time resource; when k0=1, the PDCCH message may be transmitted in a first time resource, n, and the PUSCH message may be transmitted during a second time resource, n+1, and so on. For each of k 0 and k 2, the absolute minimum value is 0. In some aspects, k0 and/or k2 may refer to a minimum guaranteed time offset, and the scheduled data message may be communicated during a time resource that is equal to or greater than the offset.

In some aspects, the minimum guaranteed scheduling offset value may have a significant impact on UE power consumption and/or latency.

FIG. 5B is a diagram illustrating an example 505 of a scheduling and decoding timeline associated with minimum scheduling offsets, in accordance with the present disclosure.

The example 505 illustrates timing considerations associated with message decoding and preparation in a single time resource.

When the minimum scheduling offset is equal to the absolute minimum scheduling offset, the UE may buffer data for an entire frequency bandwidth, and not just the data associated with the PDCCH, for example, in case the PDCCH message schedules a PDSCH message in the same slot. For example, when k0 is equal to the absolute minimum, the UE 120 may prepare to receive PDSCH in the same slot each time the UE receives a PDCCH, which may consume excessive resources in a case where PDCCH is transmitted at a time resource offset greater than the absolute minimum time offset. For example, the UE may decode DCI associated with the PDCCH relatively quickly to meet a minimum PDSCH feedback timeline. This may increase UE power consumption. When k0 is equal to the absolute minimum, the time available to decode PDSCH and prepare PUCCH may be decreased, thereby further increasing UE power consumption. When k0 is equal to the absolute minimum, the UE may be prevented, in some scenarios, from powering off radio frequency via non-scheduling carriers in the example of cross-carrier scheduling. However, when k0 is equal to the absolute minimum, communications between the UE and the network node may be associated with low latency and may be able to more easily satisfy low latency specification requirements and/or QoS requirements.

In another example, when k2 is equal to the absolute minimum, the UE may prepare to transmit PUSCH in the same slot each time the UE receives a PDCCH, which may consume excessive resources in the case where the PDCCH schedules the PUSCH during a time resource that is offset from the PDCCH by a quantity of time resources that is greater than the absolute minimum time offset. For example, the UE may decode DCI associated with the PDCCH relatively quickly to meet a minimum PDSCH feedback timeline and prepare PUSCH. This may increase UE power consumption. When k2 is equal to the absolute minimum, the time available to decode PDSCH and buffer PUSCH data may be decreased, thereby further increasing UE power consumption. When k2 is equal to the absolute minimum, the UE may also be prevented, in some scenarios, from powering off radio frequency via non-scheduling carriers, in the example of cross-carrier scheduling. Minimum values for k0/ k2 may be configured per BWP. In such examples, DCI may indicate which minimum scheduling offset value is in effect. However, this feature may rely on explicit signaling from the network node every time the minimum scheduling offset is to be changed. Thus, by using only one minimum scheduling offset value and/or consuming overhead resources to switch minimum scheduling offsets, the UE 120 may lose potential latency gains and/or power saving benefits.

As indicated above, FIG. 5 is provided as an example. Other examples may differ from what is described with respect to FIG. 5.

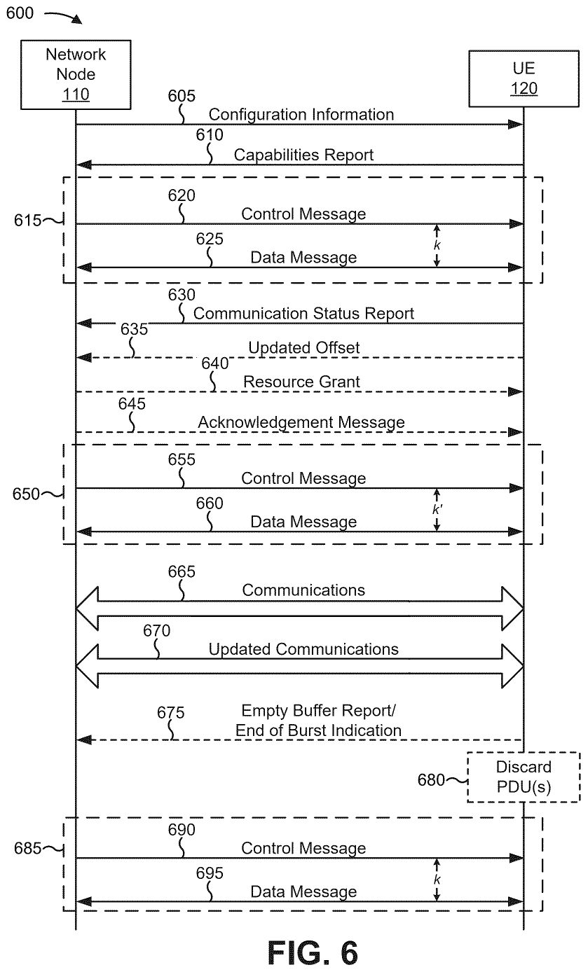

FIG. 6 is a diagram of an example 600 associated with BSR, DSR and/or scheduling request-triggered message scheduling offset switching, in accordance with the present disclosure. As shown in FIG. 6, a network node 110 (e.g., network node 110 described in connection with FIG. 1, a CU, a DU, and/or an RU) may communicate with a UE 120 (e.g., UE 120 described in connection with FIG. 1). In some aspects, the network node 110 and the UE 120 may be part of a wireless network (e.g., wireless network 100 described in connection with FIG. 1). The UE 120 and the network node 110 may have established a wireless connection prior to operations shown in FIG. 6.

As shown by reference number 605, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to perform minimum scheduling offset (e.g., minimum time offset) updating and/or switching when triggered by BSR and/or DSR reporting.

The UE 120 may configure itself based at least in part on the configuration information. In some aspects, the UE 120 may be configured to perform one or more operations described herein based at least in part on the configuration information.

As shown by reference number 610, the UE 120 may transmit, and the network node 110 may receive, a capabilities report. The capabilities report may indicate whether the UE 120 supports a feature and/or one or more parameters related to the feature. For example, the capability information may indicate a capability and/or parameter for minimum scheduling offset updating and/or switching when triggered by BSR and/or DSR reporting. As another example, the capabilities report may indicate a capability and/or parameter for a range of supported minimum scheduling offset values. One or more operations described herein may be based on capability information of the capabilities report. For example, the UE 120 may perform a communication in accordance with the capability information and/or may receive configuration information that is in accordance with the capability information. In some aspects, the capabilities report may indicate UE 120 support for updated minimum scheduling offset reporting, and/or BSR/DSR-triggered BWP configuration updating, control monitoring periodicity updating, and/or communication antenna quantity updating.

In some aspects, the configuration information described in connection with reference number 605 and/or the capabilities report described in connection with reference number 605 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 615, the UE 120 and the network node 110 may communicate according to a first minimum scheduling offset, k. For example, the UE 120 and the network node 110 may communicate a first set of one or more messages according to a minimum time offset (e.g., k0, k2) between a control message (e.g., PUCCH) and a scheduled data message (e.g., PUSCH, PDSCH).

In some aspects, communicating the first set of one or more messages may include, as shown by reference number 620, the network node 110 transmitting, and the UE 120 receiving, at a first time and/or during a first time resource, a control message. In some aspects, communicating the first set of one or more messages may include, as shown by reference number 625, the network node 110 transmitting, and the UE 120 receiving, at a second time and/or during a second time resource, a data message according to a minimum time offset k. In some aspects, communicating the first set of one or more messages may include, as shown by reference number 625, the UE 120 transmitting, and the network node 110 receiving, at the second time and/or during the second time resource, a data message according to the minimum time offset k. In some aspects, the control message, described in connection with reference number 620, may schedule the data message, described in connection with reference number 625, in a time resource that is offset from the control message by at least the minimum time offset k. For example, the second time resource may be offset from the first time resource by at least a quantity of time resources indicated by the minimum time offset k.

As shown by reference number 630, the UE 120 may transmit, and the network node 110 may receive, a communication status report. For example, the UE 120 may transmit, and the network node 110 may receive, a communication status report in association with one or more conditions, associated with communications at the UE, being satisfied.

In some aspects, the communication status report may include a BSR, a DSR, and/or a scheduling request. In some aspects, the one or more conditions may include a remaining delay budget threshold (e.g., a maximum delay associated with a PDU and/or a data packet that may occur and still satisfy a delay budget), or a buffer size threshold (e.g., a maximum quantity and/or amount of data that may be stored in a buffer at a time). For example, the UE 120 may determine that a delay associated with transmitting a data packet satisfies/exceeds and/or will satisfy and/or exceed the remaining delay budget threshold, and may trigger the communication status report. In another example, the UE 120 may determine that a buffer size associated with transmitting a data packet satisfies/exceeds and/or will satisfy and/or exceed the buffer size threshold, and may trigger the communication status report.

In some aspects, the communication status report may include a scheduling request configuration that is associated with an LCG and/or a logical channel. In such aspects, the updated minimum time offset may correspond to the scheduling request configuration. For example, logical channels may be associated with different scheduling request configurations and each scheduling request may be associated with a corresponding minimum scheduling offset and/or a corresponding updated minimum scheduling offset.

As shown by reference number 635, the UE 120 may transmit, and the network node 110 may receive, an updated offset. For example, the UE 120 may transmit, and the network node 110 may receive, an indication of an updated minimum time offset, k′. In some aspects, the UE 120 may determine to update the minimum time offset k and/or switch to communicating using an updated minimum time offset k′ in association with transmitting the communication status report described in connection with reference number 630. In some aspects, the updated minimum time offset may be smaller than the minimum time offset (for example, to satisfy latency considerations and/or requirements). In some aspects, the minimum time offset may include a default minimum time offset (e.g., k>kmin, a minimum time offset that leverages low power consumption but may increase latency), and/or the updated minimum time offset may include a relatively small minimum time offset, and/or an absolute minimum time offset (e.g., k′=kmin, k′=0, k′<k, a minimum time offset that leverages low latency but may increase power consumption of the UE 120).

In some aspects, the UE 120 may transmit, and the network node 110 may receive, a MAC-CE including the indication of the updated minimum time offset and/or the communication status report described in connection with reference number 630. For example, the indication of the updated time offset may include the communication status report, may be communicated as part of the communication status report, and/or may be communicated via separate signaling than the communication status report described in connection with reference number 630.

As shown by reference number 640, the network node 110 may transmit, and the UE 120 may receive, a resource grant. For example, the network node 110 may transmit, and the UE 120 may receive, in association with transmitting the indication of the updated minimum scheduling offset described in connection with reference number 635, a resource grant in accordance with the updated minimum time offset k′. In such examples, the network node 110 may accept and/or approve of the UE 120 and/or the network node 110 communicating according to the updated minimum scheduling offset.

In some other aspects, the network node 110 may transmit, and the UE 120 may receive, in association with transmitting the indication of the updated minimum scheduling offset described in connection with reference number 635, a resource grant in accordance with the minimum time offset. For example, the network node 110 may reject and/or disapprove of the UE 120 and/or the network node 110 communicating according to the updated minimum scheduling offset. As a result, the network node 110 may schedule communications according to the minimum scheduling offset k.

As shown by reference number 645, the network node 110 may transmit, and the UE 120 may receive, an acknowledgement message. For example, the network node 110 may transmit, and the UE 120 may receive, an acknowledgement message.

In some aspects, the acknowledgement message may include a toggled new data indicator associated with a same HARQ process as at least one of the first set of one or more messages or the second set of one or more messages. In some other aspects, the acknowledgement message may include an acknowledgement that the first set of one or more messages was received by the network node 110.

As shown by reference number 650, the UE 120 and the network node 110 may communicate according to a second minimum scheduling offset k′. For example, the UE 120 and the network node 110 may communicate a second set of one or more messages according to an updated minimum time offset (e.g., k0′, k2′) (e.g., between a second control message (e.g., PUCCH) and a scheduled second data message (e.g., PUSCH, PDSCH)) in association with transmitting the communication status report described in connection with reference number 630. In some aspects, transmitting the communication status report described in connection with reference number 630 may trigger communicating the second set of one or more messages according to the updated minimum time offset. In some aspects, communicating the second set of one or more messages according to the updated minimum time offset may include communicating the second set of one or more messages after an applicability delay that is initiated by the UE transmitting the communication status report. For example, the UE 120 and/or the network node 110 may communicate the communication status report described in connection with reference number 620 and, after an applicability delay, may apply the updated minimum scheduling offset k′ to communications between the network node 110 and/or the UE 120. As a result, the network node 110 may have sufficient time to decode a control message from the UE 120 (e.g., indicating the updated minimum scheduling offset and/or other control information) before communicating according to the updated minimum scheduling offset.

In some aspects, communicating the second set of one or more messages may include, as shown by reference number 655, the network node 110 transmitting, and the UE 120 receiving, at a third time and/or during a third time resource, a control message. In some aspects, communicating the first set of one or more messages may include, as shown by reference number 660, the network node 110 transmitting, and the UE 120 receiving, at a fourth time and/or during a fourth time resource, a data message according to the updated minimum time offset k′. In some aspects, communicating the first set of one or more messages may include, as shown by reference number 660, the UE 120 transmitting, and the network node 110 receiving, at the fourth time and/or during the fourth time resource, a data message according to the updated minimum time offset k′. In some aspects, the control message, described in connection with reference number 655, may schedule the data message, described in connection with reference number 660, in a time resource that is offset from the control message by at least the minimum time offset k′. For example, the fourth time resource may be offset from the third time resource by at least a quantity of time resources indicated by the updated minimum time offset k′.

In some aspects, communicating the second set of one or more messages according to the updated minimum time offset may be associated with and/or triggered at least in part by communicating the acknowledgement message described in connection with reference number 645.

As shown by reference number 665, the UE 120, and the network node 110 may communicate and/or exchange communications. For example, the UE 120 and the network node 110 may communicate and/or exchange communications according to a set of parameters and/or one or more communication configurations.

In some aspects, the UE 120 may communicate, with the network node 110, one or more messages according to a frequency resource configuration. In some aspects, the frequency resource configuration may include a BWP configuration. For example, a BWP configuration may include one or more bandwidth allocations for communications at the UE 120, a BWP throughput, a BWP power efficiency, an uplink BWP, and/or a downlink BWP, among other examples.

In some aspects, the UE 120 may communicate, with the network node 110, one or more messages according to a control monitoring periodicity. In some aspects, the control monitoring periodicity may indicate how frequently the UE 120 monitors for control messages and/or monitors control channels for downlink control information, such as scheduling information, and/or updates from the network node 110, among other examples.

In some aspects, the UE 120 may communicate, with the network node 110, one or more messages according to a quantity of active communication antenna elements. For example, the UE 120 may use a quantity of active downlink antenna elements for receiving communications for the network node 110 and/or may use a quantity of active uplink antenna elements for transmitting communications to the network node 110.

As shown by reference number 670, the UE 120, and the network node 110 may perform updated communications and/or exchange updated communications. For example, the UE 120 and the network node 110 may communicate and/or exchange communications according to a set of updated parameters and/or one or more updated communication configurations.

In some aspects, the UE 120 may communicate, with the network node 110, one or more messages according to an updated frequency resource configuration in association with the UE transmitting the communication status report described in connection with reference number 630. In some aspects, the updated frequency resource configuration may include an updated BWP configuration that is different from the BWP configuration. For example, an updated BWP configuration may include one or more updated bandwidth allocations for communications at the UE 120, an updated BWP throughput, an updated BWP power efficiency, an updated uplink BWP, and/or an updated downlink BWP, among other examples.

In some aspects, the UE 120 may communicate, with the network node 110, one or more messages according to an updated control monitoring periodicity in association with the UE 120 transmitting the communication status report described in connection with reference number 630. In some aspects, the updated control monitoring periodicity may update and/or change how frequently the UE 120 monitors for control messages and/or monitors control channels for downlink control information, such as scheduling information, and/or updates from the network node 110, among other examples.

In some aspects, the UE 120 may communicate, with the network node 110, one or more messages according to an updated quantity of active communication antenna elements in association with the UE 120 transmitting the communication status report described in connection with reference number 630. In some aspects, the updated quantity of active communication antenna elements may include an updated quantity of active downlink antenna elements (e.g., different from the quantity of active downlink antenna elements described in connection with reference number 665) for receiving communications for the network node 110, and/or an updated quantity of active uplink antenna elements (e.g., different from the quantity of active uplink antenna elements described in connection with reference number 665) for transmitting communications to the network node 110.

As shown by reference number 675, the UE 120 may transmit, and the network node 110 may receive, an empty buffer status report and/or an end of burst indication. For example, the UE 120 may transmit, and the network node 110 may receive, a buffer status report that indicates an empty buffer of the UE. In some aspects, the UE 120 may transmit, and the network node 110 may receive, an end of burst indication. For example, the end of burst indication may indicate a conclusion of a set of uplink message transmissions transmitted in relative proximity in time and/or may indicate a conclusion of a set of uplink message transmissions that are associated with each other (e.g., associated with a same application, include discrete portions of a dataset, among other examples).

As shown by reference number 680, the UE 120 may discard one or more PDUs. For example, the UE 120 may discard a set of one or more PDUs in accordance with and/or based on an expiration of a discard timer associated with the communication status report described in connection with reference number 630.

As shown by reference number 685, the UE 120 and the network node 110 may communicate according to the first minimum scheduling offset k. For example, the UE 120 and the network node 110 may communicate a third set of one or more messages according to the minimum time offset (e.g., k0, k2) (e.g., between a third control message (e.g., PUCCH) and a third scheduled data message (e.g., PUSCH, PDSCH)).

In some aspects, communicating the third set of one or more messages may include, as shown by reference number 690, the network node 110 transmitting, and the UE 120 receiving, at a fifth time and/or during a fifth time resource, a control message. In some aspects, communicating the third set of one or more messages may include, as shown by reference number 695, the network node 110 transmitting, and the UE 120 receiving, at a sixth time and/or during a sixth time resource, a data message according to a minimum time offset k. In some aspects, communicating the third set of one or more messages may include, as shown by reference number 695, the UE 120 transmitting, and the network node 110 receiving, at the sixth time and/or during the sixth time resource, a data message according to the minimum time offset k. In some aspects, the control message, described in connection with reference number 690, may schedule the data message, described in connection with reference number 695, in a time resource that is offset from the control message by at least the minimum time offset k. For example, the sixth time resource may be offset from the fifth time resource by at least a quantity of time resources indicated by the minimum time offset k.

In some aspects, communicating the third set of one or more messages may be associated with and/or triggered by transmitting the buffer status report described in connection with reference number 675. In some aspects, communicating the third set of one or more messages may be associated with transmitting the end of burst indication described in connection with reference number 675. In some aspects, communicating the third set of one or more messages according to the minimum time offset may be associated with discarding the set of one or more PDUs described in connection with reference number 680.

As indicated above, FIG. 6 is provided as an example. Other examples may differ from what is described with respect to FIG. 6.

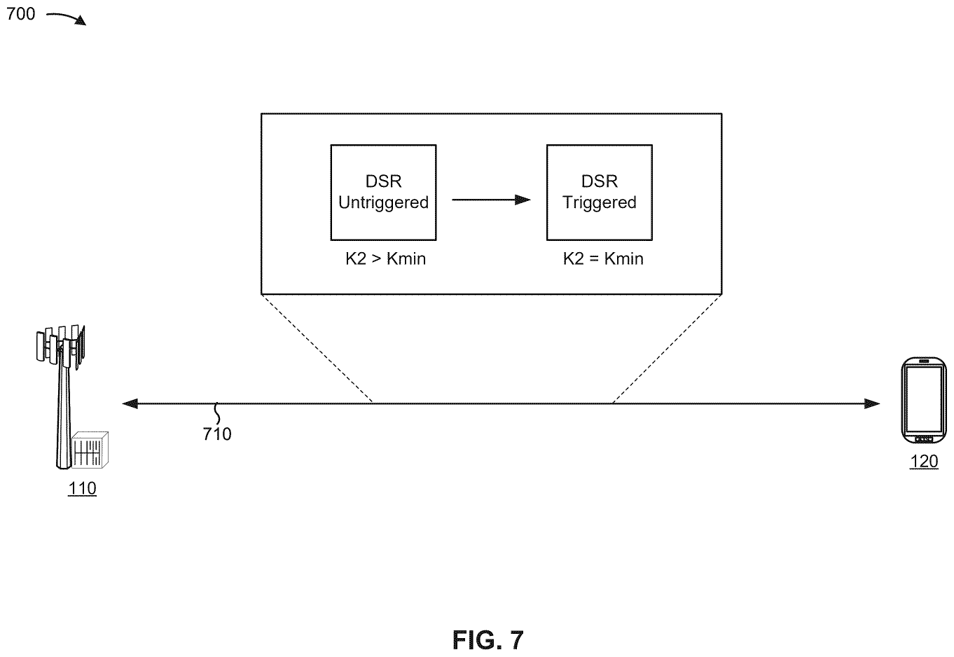

FIG. 7 is a diagram illustrating an example 700 associated with updating a minimum scheduling offset in association with channel conditions and/or latency considerations, in accordance with the present disclosure. As shown in FIG. 7, example 700 includes communication between a network node 110 and a UE 120. In some aspects, the network node 110 and the UE 120 may be included in a wireless network, such as wireless network 100. The network node 110 and the UE 120 may communicate via a wireless access link 710, which may include an uplink and a downlink.

The UE 120 may transmit a DSR and/or BSR including one or more RDB values that are less than a configurable threshold and/or indicating a buffer size that is greater than a configurable threshold. In such aspects, the UE 120 may switch from communicating using a first minimum scheduling offset (e.g., a first k2>kmin) to communicating using a second minimum scheduling offset (e.g., a second k2=kmin) which may be smaller than the first minimum scheduling offset. For example, the UE 120 may default to communicating using a minimum scheduling offset that is greater than an absolute minimum (e.g., k2>kmin) and may switch to communicating using a minimum scheduling offset that is equal to the absolute minimum (e.g., k2=kmin) when the UE 120 transmits a BSR with a reported buffer size that is greater than the threshold.

When the delay budget is greater than a threshold and/or the BSR indicates a buffer size that is greater than a threshold, the UE 120 may be in a scenario where meeting key performance indicators (KPIs) is important (e.g., may be in a critical situation in which the UE 120 is to meet KPIs) and may communicate using a relatively small minimum time offset and/or an absolute minimum time offset to reduce latency. However, communicating using a relatively small minimum time offset and/or an absolute minimum scheduling offset may consume more power than communicating using a minimum scheduling offset that is larger than the relatively small minimum time offset and/or the absolute minimum time offset. For example, in other scenarios, meeting latency requirements may not be as important, and thus the UE 120 may conserve power by communicating using a minimum time offset that is larger than the relatively small minimum time offset and/or the absolute minimum time offset. Switching between minimum time offsets may strike a balance between UE power consumption and latency requirements.

In some aspects, after a DSR is triggered and/or a BSR is transmitted by the UE 120, the network node 110 and/or the UE 120 may apply the second minimum scheduling offset (e.g., k2=kmin). In some aspects, the network node 110 and/or the UE 120 may apply the second minimum scheduling offset (e.g., k2=kmin) after the UE 120 transmits the DSR and/or the BSR. In some aspects, the network node 110 and/or the UE 120 may apply the second minimum scheduling offset (e.g., k2=kmin) after an applicability delay. For example, the applicability delay may include time for the network node 110 to decode a control message (e.g., MAC-CE) before applying the second minimum scheduling offset.

In some aspects, the network node 110 and/or the UE 120 may apply the second minimum scheduling offset (e.g., k2=kmin) after the network node 110 transmits an ACK in the form of an new data indicator that is toggled for the same HARQ process that is associated with communications using the first minimum scheduling offset. For example, the network node 110 may transmit the toggled new data indicator, and the UE 120 may identify that the network node 110 successfully received the uplink data transmitted according to the first minimum scheduling offset. In some aspects, the network node 110 and/or the UE 120 may apply the second minimum scheduling offset (e.g., k2=kmin) after the network node 110 transmits an explicit ACK. For example, the network node 110 may transmit a HARQ ACK message indicating that the network node 110 successfully received the uplink data transmitted according to the first minimum scheduling offset.

The network node 110 and/or the UE 120 may switch back to communicating using the first minimum scheduling offset after communicating using the second minimum scheduling offset. For example, the network node 110 and/or the UE 120 may switch back to communicating using the first minimum scheduling offset when the UE 120 transmits an indication of a subsequent zero buffer. For example, the UE 120 may transmit a BSR indicating an empty buffer and/or a null buffer size. In some aspects, the network node 110 and/or the UE 120 may switch back to communicating using the first minimum scheduling offset when the UE 120 transmits an end of uplink burst indication. For example, the UE 120 may indicate that a burst of uplink transmissions (e.g., associated with low latency requirements) has concluded. In some aspects, the network node 110 and/or the UE 120 may switch back to communicating using the first minimum scheduling offset when a PDCP discard timer for which the UE 120 transmitted the RDB expires and the UE 120 discards the uplink PDUs (e.g., the uplink PDUs associated with the PDCP discard timer).

In some aspects, the UE 120 may transmit and/or report an indication of the updated minimum scheduling offset in a same control message as the communication status report (e.g., BSR, DSR, scheduling request). In such aspects, the network node 110 may accept and/or reject the updated minimum scheduling offset. For example, the network node 110 may reject the updated minimum scheduling offset and may schedule data messages, in subsequent resource grants (e.g., dynamic grants, configured grants), according to a scheduling offset that is compliant with the first minimum scheduling offset and not the updated minimum scheduling offset. In some other examples, the network node 110 may accept the updated minimum scheduling offset and may schedule data messages, in subsequent resource grants (e.g., dynamic grants, configured grants), according to a scheduling offset that is compliant with the updated minimum scheduling offset and not the first minimum scheduling offset.

In some aspects, when logical channels are associated with different scheduling request configurations, when the UE 120 flags and/or transmits a scheduling request (e.g., for a particular logical channel), there may be a corresponding minimum scheduling offset associated with the scheduling request. For example, the UE 120 may transmit a scheduling request for a logical channel that is associated with a different minimum scheduling offset than the first minimum scheduling offset. As a result, subsequent communications may be based on or in accordance with the different minimum scheduling offset (e.g., that is associated with the scheduling request and/or the logical channel).

Further, similarly to how the UE 120 and/or the network node 110 may update the minimum scheduling offset for communications after a BSR, DSR, and/or scheduling request, the UE 120 and/or the network node 110 may update other parameters and/or configurations after a BSR, DSR, and/or scheduling request is triggered in response to one or more conditions, associated with communications at the UE 120, being satisfied. For example, the UE 120 and/or the network node 110 may switch to communicating using an updated BWP configuration, an updated control monitoring periodicity, and/or an updated quantity of activated uplink and/or downlink antennas (e.g., antennas, antenna elements).

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with reporting-triggered message offset update.

As shown in FIG. 8, in some aspects, process 800 may include communicating, with a network node, a first set of one or more messages according to a minimum time offset between a control message and a data message (block 810). For example, the UE (e.g., using reception component 1002, transmission component 1004, and/or communication manager 1006, depicted in FIG. 10) may communicate, with a network node, a first set of one or more messages according to a minimum time offset between a control message and a data message, as described above.

As further shown in FIG. 8, in some aspects, process 800 may include transmitting a communication status report in association with one or more conditions, associated with communications at the UE, being satisfied (block 820). For example, the UE (e.g., using transmission component 1004 and/or communication manager 1006, depicted in FIG. 10) may transmit a communication status report in association with one or more conditions, associated with communications at the UE, being satisfied, as described above.

As further shown in FIG. 8, in some aspects, process 800 may include communicating, with the network node, a second set of one or more messages according to an updated minimum time offset in association with transmitting the communication status report (block 830). For example, the UE (e.g., using reception component 1002, transmission component 1004, and/or communication manager 1006, depicted in FIG. 10) may communicate, with the network node, a second set of one or more messages according to an updated minimum time offset in association with transmitting the communication status report, as described above.

Process 800 may include additional aspects, such as any single aspect or any combination of aspects described below and/or in connection with one or more other processes described elsewhere herein.

In a first aspect, communicating the second set of one or more messages according to the updated minimum time offset comprises receiving, at a first time from the network node, an additional control message that schedules resources for an uplink data message, and transmitting, at a second time, the uplink data message, wherein the second time is offset from the first time by at least the updated minimum time offset.

In a second aspect, alone or in combination with the first aspect, process 800 includes communicating, with the network node, one or more messages according to a frequency resource configuration, and communicating, with the network node, one or more messages according to an updated frequency resource configuration in association with transmitting the communication status report.

In a third aspect, alone or in combination with one or more of the first and second aspects, process 800 includes communicating, with the network node, one or more messages according to a control monitoring periodicity, and communicating, with the network node, one or more messages according to an updated control monitoring periodicity in association with transmitting the communication status report.

In a fourth aspect, alone or in combination with one or more of the first through third aspects, process 800 includes communicating, with the network node, one or more messages using a quantity of active communication antenna elements, and communicating, with the network node, one or more messages using an updated quantity of active communication antenna elements in association with transmitting the communication status report.

In a fifth aspect, alone or in combination with one or more of the first through fourth aspects, process 800 includes transmitting, to the network node, an indication of the updated minimum time offset.

In a sixth aspect, alone or in combination with one or more of the first through fifth aspects, transmitting the indication of the updated minimum time offset comprises transmitting a MAC-CE including the indication of the updated minimum time offset and the communication status report.

In a seventh aspect, alone or in combination with one or more of the first through sixth aspects, process 800 includes receiving, in association with transmitting the indication, a resource grant in accordance with the updated minimum time offset.

In an eighth aspect, alone or in combination with one or more of the first through seventh aspects, process 800 includes receiving, in association with transmitting the indication, a resource grant in accordance with the minimum time offset.

In a ninth aspect, alone or in combination with one or more of the first through eighth aspects, the updated minimum time offset is smaller than the minimum time offset.

In a tenth aspect, alone or in combination with one or more of the first through ninth aspects, the communication status report includes at least one of a buffer status report, a delay status report, or a scheduling request.

In an eleventh aspect, alone or in combination with one or more of the first through tenth aspects, the one or more conditions include at least one of a remaining delay budget threshold, or a buffer size threshold.

In a twelfth aspect, alone or in combination with one or more of the first through eleventh aspects, the minimum time offset comprises a default minimum time offset, and the updated minimum time offset comprises an absolute minimum time offset.

In a thirteenth aspect, alone or in combination with one or more of the first through twelfth aspects, transmitting the communication status report triggers communicating the second set of one or more messages according to the updated minimum time offset.

In a fourteenth aspect, alone or in combination with one or more of the first through thirteenth aspects, communicating the second set of one or more messages according to the updated minimum time offset comprises communicating the second set of one or more messages after an applicability delay that is initiated by the UE transmitting the communication status report.

In a fifteenth aspect, alone or in combination with one or more of the first through fourteenth aspects, process 800 includes receiving, from the network node, an acknowledgement message, wherein communicating the second set of one or more messages according to the updated minimum time offset is associated with receiving the acknowledgement message.

In a sixteenth aspect, alone or in combination with one or more of the first through fifteenth aspects, the acknowledgement message includes a toggled new data indicator associated with a same hybrid automatic repeat request process as at least one of the first set of one or more messages or the second set of one or more messages.

In a seventeenth aspect, alone or in combination with one or more of the first through sixteenth aspects, the acknowledgement message includes an acknowledgement that the first set of one or more messages was received by the network node.

In an eighteenth aspect, alone or in combination with one or more of the first through seventeenth aspects, process 800 includes communicating a third set of one or more messages according to the minimum time offset.

In a nineteenth aspect, alone or in combination with one or more of the first through eighteenth aspects, process 800 includes transmitting a buffer status report that indicates an empty buffer of the UE, wherein communicating the third set of one or more messages is associated with transmitting the buffer status report.

In a twentieth aspect, alone or in combination with one or more of the first through nineteenth aspects, process 800 includes transmitting an end of burst indication, wherein communicating the third set of one or more messages is associated with transmitting the end of burst indication.

In a twenty-first aspect, alone or in combination with one or more of the first through twentieth aspects, process 800 includes discarding a set of one or more packet data units in accordance with an expiration of a discard timer associated with the communication status report, wherein communicating the third set of one or more messages according to the minimum time offset is associated with discarding the set of one or more packet data units.

In a twenty-second aspect, alone or in combination with one or more of the first through twenty-first aspects, the communication status report includes a scheduling request configuration that is associated with a logical channel group, and the updated minimum time offset corresponds to the scheduling request configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with reporting-triggered message offset update.

As shown in FIG. 9, in some aspects, process 900 may include communicating, with a UE, a first set of one or more messages according to a minimum time offset between a control message and a data message (block 910). For example, the network node (e.g., using reception component 1102, transmission component 1104, and/or communication manager 1106, depicted in FIG. 11) may communicate, with a UE, a first set of one or more messages according to a minimum time offset between a control message and a data message, as described above.

As further shown in FIG. 9, in some aspects, process 900 may include receiving a communication status report indicating that one or more conditions, associated with communications at the UE, are satisfied (block 920). For example, the network node (e.g., using reception component 1102 and/or communication manager 1106, depicted in FIG. 11) may receive a communication status report indicating that one or more conditions, associated with communications at the UE, are satisfied, as described above.

As further shown in FIG. 9, in some aspects, process 900 may include communicating, with the UE, a second set of one or more messages according to an updated minimum time offset in association with transmitting the communication status report (block 930). For example, the network node (e.g., using reception component 1102, transmission component 1104, and/or communication manager 1106, depicted in FIG. 11) may communicate, with the UE, a second set of one or more messages according to an updated minimum time offset in association with transmitting the communication status report, as described above.

Process 900 may include additional aspects, such as any single aspect or any combination of aspects described below and/or in connection with one or more other processes described elsewhere herein.

In a first aspect, communicating the second set of one or more messages according to the updated minimum time offset comprises transmitting an additional control message that schedules resources for an uplink data message, and receiving, according to the updated minimum time offset, the uplink data message.

In a second aspect, alone or in combination with the first aspect, process 900 includes communicating, with the UE, one or more messages according to a frequency resource configuration, and communicating, with the UE, one or more messages according to an updated frequency resource configuration in association with receiving the communication status report.

In a third aspect, alone or in combination with one or more of the first and second aspects, process 900 includes communicating, with the UE, one or more messages according to a control monitoring periodicity, and communicating, with the UE, one or more messages according to an updated control monitoring periodicity in association with receiving the communication status report.

In a fourth aspect, alone or in combination with one or more of the first through third aspects, process 900 includes receiving, from the UE, an indication of the updated minimum time offset.

In a fifth aspect, alone or in combination with one or more of the first through fourth aspects, receiving the indication of the updated minimum time offset comprises receiving a MAC-CE including the indication of the updated minimum time offset and the communication status report.

In a sixth aspect, alone or in combination with one or more of the first through fifth aspects, process 900 includes transmitting, in association with receiving the indication, a resource grant in accordance with the updated minimum time offset.

In a seventh aspect, alone or in combination with one or more of the first through sixth aspects, process 900 includes transmitting, in association with receiving the indication, a resource grant in accordance with the minimum time offset.

In an eighth aspect, alone or in combination with one or more of the first through seventh aspects, the updated minimum time offset is smaller than the minimum time offset.

In a ninth aspect, alone or in combination with one or more of the first through eighth aspects, the communication status report includes at least one of a buffer status report, a delay status report, or a scheduling request.

In a tenth aspect, alone or in combination with one or more of the first through ninth aspects, the one or more conditions include at least one of a remaining delay budget threshold, or a buffer size threshold.

In an eleventh aspect, alone or in combination with one or more of the first through tenth aspects, the minimum time offset comprises a default minimum time offset, and the updated minimum time offset comprises an absolute minimum time offset.

In a twelfth aspect, alone or in combination with one or more of the first through eleventh aspects, receiving the communication status report is associated with communicating the second set of one or more messages according to the updated minimum time offset.

In a thirteenth aspect, alone or in combination with one or more of the first through twelfth aspects, communicating the second set of one or more messages according to the updated minimum time offset comprises communicating the second set of one or more messages after an applicability delay that is initiated by the UE transmitting the communication status report.

In a fourteenth aspect, alone or in combination with one or more of the first through thirteenth aspects, process 900 includes decoding, during the applicability delay, a control message associated with the second set of one or more messages.

In a fifteenth aspect, alone or in combination with one or more of the first through fourteenth aspects, process 900 includes transmitting, to the UE, an acknowledgement message, wherein communicating the second set of one or more messages according to the updated minimum time offset is associated with transmitting the acknowledgement message.

In a sixteenth aspect, alone or in combination with one or more of the first through fifteenth aspects, the acknowledgement message includes a toggled new data indicator associated with a same hybrid automatic repeat request process as at least one of the first set of one or more messages or the second set of one or more messages.

In a seventeenth aspect, alone or in combination with one or more of the first through sixteenth aspects, the acknowledgement message includes an acknowledgement that the first set of one or more messages was received by the network node.

In an eighteenth aspect, alone or in combination with one or more of the first through seventeenth aspects, process 900 includes communicating a third set of one or more messages according to the minimum time offset.

In a nineteenth aspect, alone or in combination with one or more of the first through eighteenth aspects, process 900 includes receiving a buffer status report that indicates an empty buffer of the UE, wherein communicating the third set of one or more messages is associated with receiving the buffer status report.

In a twentieth aspect, alone or in combination with one or more of the first through nineteenth aspects, process 900 includes receiving an end of burst indication, wherein communicating the third set of one or more messages is associated with receiving the end of burst indication.

In a twenty-first aspect, alone or in combination with one or more of the first through twentieth aspects, the communication status report includes a scheduling request configuration that is associated with a logical channel group, and the updated minimum time offset corresponds to the scheduling request configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 6-7 Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 and/or the transmission component 1004 may communicate, with a network node, a first set of one or more messages according to a minimum time offset between a control message and a data message. The transmission component 1004 may transmit a communication status report in association with one or more conditions, associated with communications at the UE, being satisfied. The reception component 1002 and/or the transmission component 1004 may communicate, with the network node, a second set of one or more messages according to an updated minimum time offset in association with transmitting the communication status report.

The reception component 1002 may receive, at a first time from the network node, an additional control message that schedules resources for an uplink data message.

The transmission component 1004 may transmit, at a second time, the uplink data message, wherein the second time is offset from the first time by at least the updated minimum time offset.

The communication manager 1006 may communicate, with the network node, one or more messages according to a frequency resource configuration.

The communication manager 1006 may communicate, with the network node, one or more messages according to an updated frequency resource configuration in association with transmitting the communication status report.

The communication manager 1006 may communicate, with the network node, one or more messages according to a control monitoring periodicity. The communication manager 1006 may communicate, with the network node, one or more messages according to an updated control monitoring periodicity in association with transmitting the communication status report. The communication manager 1006 may communicate, with the network node, one or more messages using a quantity of active communication antenna elements. The communication manager 1006 may communicate, with the network node, one or more messages using an updated quantity of active communication antenna elements in association with transmitting the communication status report.

The transmission component 1004 may transmit, to the network node, an indication of the updated minimum time offset. The reception component 1002 may receive, in association with transmitting the indication, a resource grant in accordance with the updated minimum time offset. The reception component 1002 may receive, in association with transmitting the indication, a resource grant in accordance with the minimum time offset. The reception component 1002 may receive, from the network node, an acknowledgement message, wherein communicating the second set of one or more messages according to the updated minimum time offset is associated with receiving the acknowledgement message.

The communication manager 1006 may communicate a third set of one or more messages according to the minimum time offset.

The transmission component 1004 may transmit a buffer status report that indicates an empty buffer of the UE, wherein communicating the third set of one or more messages is associated with transmitting the buffer status report.

The transmission component 1004 may transmit an end of burst indication, wherein communicating the third set of one or more messages is associated with transmitting the end of burst indication.

The communication manager 1006 may discard a set of one or more packet data units in accordance with an expiration of a discard timer associated with the communication status report, wherein communicating the third set of one or more messages according to the minimum time offset is associated with discarding the set of one or more packet data units.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 6-7. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 and/or the transmission component 1104 may communicate, with a UE, a first set of one or more messages according to a minimum time offset between a control message and a data message. The reception component 1102 may receive a communication status report indicating that one or more conditions, associated with communications at the UE, are satisfied. The reception component 1102 and/or the transmission component 1104 may communicate, with the UE, a second set of one or more messages according to an updated minimum time offset in association with transmitting the communication status report.

The transmission component 1104 may transmit an additional control message that schedules resources for an uplink data message. The reception component 1102 may receive, according to the updated minimum time offset, the uplink data message.

The communication manager 1106 may communicate, with the UE, one or more messages according to a frequency resource configuration. The communication manager 1106 may communicate, with the UE, one or more messages according to an updated frequency resource configuration in association with receiving the communication status report. The communication manager 1106 may communicate, with the UE, one or more messages according to a control monitoring periodicity.

The communication manager 1106 may communicate, with the UE, one or more messages according to an updated control monitoring periodicity in association with receiving the communication status report. The reception component 1102 may receive, from the UE, an indication of the updated minimum time offset.

The transmission component 1104 may transmit, in association with receiving the indication, a resource grant in accordance with the updated minimum time offset. The transmission component 1104 may transmit, in association with receiving the indication, a resource grant in accordance with the minimum time offset. The communication manager 1106 may decode, during the applicability delay, a control message associated with the second set of one or more messages. The transmission component 1104 may transmit, to the UE, an acknowledgement message, wherein communicating the second set of one or more messages according to the updated minimum time offset is associated with transmitting the acknowledgement message.

The communication manager 1106 may communicate a third set of one or more messages according to the minimum time offset. The reception component 1102 may receive a buffer status report that indicates an empty buffer of the UE, wherein communicating the third set of one or more messages is associated with receiving the buffer status report. The reception component 1102 may receive an end of burst indication, wherein communicating the third set of one or more messages is associated with receiving the end of burst indication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: communicating, with a network node, a first set of one or more messages according to a minimum time offset between a control message and a data message; transmitting a communication status report in association with one or more conditions, associated with communications at the UE, being satisfied; and communicating, with the network node, a second set of one or more messages according to an updated minimum time offset in association with transmitting the communication status report.
Aspect 2: The method of Aspect 1, wherein communicating the second set of one or more messages according to the updated minimum time offset comprises: receiving, at a first time from the network node, an additional control message that schedules resources for an uplink data message; and transmitting, at a second time, the uplink data message, wherein the second time is offset from the first time by at least the updated minimum time offset.
Aspect 3: The method of any of Aspects 1-2, further comprising: communicating, with the network node, one or more messages according to a frequency resource configuration; and communicating, with the network node, one or more messages according to an updated frequency resource configuration in association with transmitting the communication status report.
Aspect 4: The method of any of Aspects 1-3, further comprising: communicating, with the network node, one or more messages according to a control monitoring periodicity; and communicating, with the network node, one or more messages according to an updated control monitoring periodicity in association with transmitting the communication status report.
Aspect 5: The method of any of Aspects 1-4, further comprising: communicating, with the network node, one or more messages using a quantity of active communication antenna elements; and communicating, with the network node, one or more messages using an updated quantity of active communication antenna elements in association with transmitting the communication status report.
Aspect 6: The method of any of Aspects 1-5, further comprising: transmitting, to the network node, an indication of the updated minimum time offset.
Aspect 7: The method of Aspect 6, wherein transmitting the indication of the updated minimum time offset comprises: transmitting a medium access control control element including the indication of the updated minimum time offset and the communication status report.
Aspect 8: The method of any of Aspects 6-7, further comprising: receiving, in association with transmitting the indication, a resource grant in accordance with the updated minimum time offset.
Aspect 9: The method of any of Aspects 6-8, further comprising: receiving, in association with transmitting the indication, a resource grant in accordance with the minimum time offset.
Aspect 10: The method of any of Aspects 1-9, wherein the updated minimum time offset is smaller than the minimum time offset.
Aspect 11: The method of any of Aspects 1-10, wherein the communication status report includes at least one of: a buffer status report, a delay status report, or a scheduling request.
Aspect 12: The method of any of Aspects 1-11, wherein the one or more conditions include at least one of: a remaining delay budget threshold, or a buffer size threshold.
Aspect 13: The method of any of Aspects 1-12, wherein the minimum time offset comprises a default minimum time offset, and the updated minimum time offset comprises an absolute minimum time offset.
Aspect 14: The method of any of Aspects 1-13, wherein transmitting the communication status report triggers communicating the second set of one or more messages according to the updated minimum time offset.
Aspect 15: The method of any of Aspects 1-14, wherein communicating the second set of one or more messages according to the updated minimum time offset comprises: communicating the second set of one or more messages after an applicability delay that is initiated by the UE transmitting the communication status report.
Aspect 16: The method of any of Aspects 1-15, further comprising: receiving, from the network node, an acknowledgement message, wherein communicating the second set of one or more messages according to the updated minimum time offset is associated with receiving the acknowledgement message.
Aspect 17: The method of Aspect 16, wherein the acknowledgement message includes a toggled new data indicator associated with a same hybrid automatic repeat request process as at least one of the first set of one or more messages or the second set of one or more messages.
Aspect 18: The method of Aspect 16, wherein the acknowledgement message includes an acknowledgement that the first set of one or more messages was received by the network node.
Aspect 19: The method of any of Aspects 1-18, further comprising: communicating a third set of one or more messages according to the minimum time offset.
Aspect 20: The method of Aspect 19, further comprising: transmitting a buffer status report that indicates an empty buffer of the UE, wherein communicating the third set of one or more messages is associated with transmitting the buffer status report.
Aspect 21: The method of Aspect 19, further comprising: transmitting an end of burst indication, wherein communicating the third set of one or more messages is associated with transmitting the end of burst indication.
Aspect 22: The method of Aspect 19, further comprising: discarding a set of one or more packet data units in accordance with an expiration of a discard timer associated with the communication status report, wherein communicating the third set of one or more messages according to the minimum time offset is associated with discarding the set of one or more packet data units.
Aspect 23: The method of any of Aspects 1-22, wherein: the communication status report includes a scheduling request configuration that is associated with a logical channel group, and the updated minimum time offset corresponds to the scheduling request configuration.
Aspect 24: A method of wireless communication performed by a network node, comprising: communicating, with a user equipment (UE), a first set of one or more messages according to a minimum time offset between a control message and a data message; receiving a communication status report indicating that one or more conditions, associated with communications at the UE, are satisfied; and communicating, with the UE, a second set of one or more messages according to an updated minimum time offset in association with transmitting the communication status report.
Aspect 25: The method of Aspect 24, wherein communicating the second set of one or more messages according to the updated minimum time offset comprises: transmitting an additional control message that schedules resources for an uplink data message; and receiving, according to the updated minimum time offset, the uplink data message.
Aspect 26: The method of any of Aspects 24-25, further comprising: communicating, with the UE, one or more messages according to a frequency resource configuration; and communicating, with the UE, one or more messages according to an updated frequency resource configuration in association with receiving the communication status report.
Aspect 27: The method of any of Aspects 24-26, communicating, with the UE, one or more messages according to a control monitoring periodicity; and communicating, with the UE, one or more messages according to an updated control monitoring periodicity in association with receiving the communication status report.
Aspect 28: The method of any of Aspects 24-27, further comprising: receiving, from the UE, an indication of the updated minimum time offset.
Aspect 29: The method of Aspect 28, wherein receiving the indication of the updated minimum time offset comprises: receiving a medium access control control element including the indication of the updated minimum time offset and the communication status report.
Aspect 30: The method of any of Aspects 28-29, further comprising: transmitting, in association with receiving the indication, a resource grant in accordance with the updated minimum time offset.
Aspect 31: The method of any of Aspects 28-30, further comprising: transmitting, in association with receiving the indication, a resource grant in accordance with the minimum time offset.
Aspect 32: The method of any of Aspects 24-31, wherein the updated minimum time offset is smaller than the minimum time offset.
Aspect 33: The method of any of Aspects 24-32, wherein the communication status report includes at least one of: a buffer status report, a delay status report, or a scheduling request.
Aspect 34: The method of any of Aspects 24-33, wherein the one or more conditions include at least one of: a remaining delay budget threshold, or a buffer size threshold.
Aspect 35: The method of any of Aspects 24-34, wherein the minimum time offset comprises a default minimum time offset, and the updated minimum time offset comprises an absolute minimum time offset.
Aspect 36: The method of any of Aspects 24-35, wherein receiving the communication status report is associated with communicating the second set of one or more messages according to the updated minimum time offset.
Aspect 37: The method of any of Aspects 24-36, wherein communicating the second set of one or more messages according to the updated minimum time offset comprises: communicating the second set of one or more messages after an applicability delay that is initiated by the UE transmitting the communication status report.
Aspect 38: The method of Aspect 37, further comprising: decoding, during the applicability delay, a control message associated with the second set of one or more messages.
Aspect 39: The method of any of Aspects 24-38, further comprising: transmitting, to the UE, an acknowledgement message, wherein communicating the second set of one or more messages according to the updated minimum time offset is associated with transmitting the acknowledgement message.
Aspect 40: The method of Aspect 39, wherein the acknowledgement message includes a toggled new data indicator associated with a same hybrid automatic repeat request process as at least one of the first set of one or more messages or the second set of one or more messages.
Aspect 41: The method of Aspect 39, wherein the acknowledgement message includes an acknowledgement that the first set of one or more messages was received by the network node.
Aspect 42: The method of any of Aspects 24-41, further comprising: communicating a third set of one or more messages according to the minimum time offset.
Aspect 43: The method of Aspect 42, further comprising: receiving a buffer status report that indicates an empty buffer of the UE, wherein communicating the third set of one or more messages is associated with receiving the buffer status report.
Aspect 44: The method of Aspect 42, further comprising: receiving an end of burst indication, wherein communicating the third set of one or more messages is associated with receiving the end of burst indication.
Aspect 45: The method of any of Aspects 24-44, wherein: the communication status report includes a scheduling request configuration that is associated with a logical channel group, and the updated minimum time offset corresponds to the scheduling request configuration.
Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-45.
Aspect 47: An apparatus for wireless communication at a device, the apparatus comprising one or more memories and one or more processors coupled to the one or more memories, the one or more processors configured to cause the device to perform the method of one or more of Aspects 1-45.
Aspect 48: An apparatus for wireless communication, the apparatus comprising at least one means for performing the method of one or more of Aspects 1-45.
Aspect 49: A non-transitory computer-readable medium storing code for wireless communication, the code comprising instructions executable by one or more processors to perform the method of one or more of Aspects 1-45.
Aspect 50: A non-transitory computer-readable medium storing a set of instructions for wireless communication, the set of instructions comprising one or more instructions that, when executed by one or more processors of a device, cause the device to perform the method of one or more of Aspects 1-45.
Aspect 51: A device for wireless communication, the device comprising a processing system that includes one or more processors and one or more memories coupled with the one or more processors, the processing system configured to cause the device to perform the method of one or more of Aspects 1-45.
Aspect 52: An apparatus for wireless communication at a device, the apparatus comprising one or more memories and one or more processors coupled to the one or more memories, the one or more processors individually or collectively configured to cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
communicate, with a network node, a first set of one or more messages according to a minimum time offset between a control message and a data message;
transmit a communication status report in association with one or more conditions, associated with communications at the UE, being satisfied; and
communicate, with the network node, a second set of one or more messages according to an updated minimum time offset in association with transmitting the communication status report.

2. The apparatus of claim 1, wherein the one or more processors, to cause the UE to communicate the second set of one or more messages according to the updated minimum time offset, are configured to cause the UE to:
receive, at a first time from the network node, an additional control message that schedules resources for an uplink data message; and
transmit, at a second time, the uplink data message, wherein the second time is offset from the first time by at least the updated minimum time offset.

3. The apparatus of claim 1, wherein the one or more processors are further configured to cause the UE to:
communicate, with the network node, one or more messages according to a frequency resource configuration; and
communicate, with the network node, one or more messages according to an updated frequency resource configuration in association with transmitting the communication status report.

4. The apparatus of claim 1, wherein the one or more processors are further configured to cause the UE to:
communicate, with the network node, one or more messages according to a control monitoring periodicity; and
communicate, with the network node, one or more messages according to an updated control monitoring periodicity in association with transmitting the communication status report.

5. The apparatus of claim 1, wherein the one or more processors are further configured to cause the UE to:
communicate, with the network node, one or more messages using a quantity of active communication antenna elements; and
communicate, with the network node, one or more messages using an updated quantity of active communication antenna elements in association with transmitting the communication status report.

6. The apparatus of claim 1, wherein the one or more processors are further configured to cause the UE to:
transmit, to the network node, an indication of the updated minimum time offset.

7. The apparatus of claim 6, wherein the one or more processors, to cause the UE to transmit the indication of the updated minimum time offset, are configured to cause the UE to:
transmit a medium access control control element including the indication of the updated minimum time offset and the communication status report.

8. The apparatus of claim 6, wherein the one or more processors are further configured to cause the UE to:
receive, in association with transmitting the indication, a resource grant in accordance with the updated minimum time offset.

9. The apparatus of claim 6, wherein the one or more processors are further configured to cause the UE to:
receive, in association with transmitting the indication, a resource grant in accordance with the minimum time offset.

10. An apparatus for wireless communication at a network node, comprising:
one or more memories; and
one or more processors, coupled to the one or more memories, configured to cause the network node to:
communicate, with a user equipment (UE), a first set of one or more messages according to a minimum time offset between a control message and a data message;
receive a communication status report indicating that one or more conditions, associated with communications at the UE, are satisfied; and
communicate, with the UE, a second set of one or more messages according to an updated minimum time offset in association with transmitting the communication status report.

11. The apparatus of claim 10, wherein the updated minimum time offset is smaller than the minimum time offset.

12. The apparatus of claim 10, wherein the communication status report includes at least one of:
a buffer status report,
a delay status report, or
a scheduling request.

13. The apparatus of claim 10, wherein the one or more conditions include at least one of:
a remaining delay budget threshold, or
a buffer size threshold.

14. The apparatus of claim 10, wherein the minimum time offset comprises a default minimum time offset, and the updated minimum time offset comprises an absolute minimum time offset.

15. The apparatus of claim 10, wherein receiving the communication status report is associated with communicating the second set of one or more messages according to the updated minimum time offset.

16. The apparatus of claim 10, wherein the one or more processors, to cause the network node to communicate the second set of one or more messages according to the updated minimum time offset, are configured to cause the network node to:
communicate the second set of one or more messages after an applicability delay that is initiated by the UE transmitting the communication status report.

17. The apparatus of claim 16, wherein the one or more processors are further configured to cause the network node to:
decode, during the applicability delay, a control message associated with the second set of one or more messages.

18. The apparatus of claim 10, wherein the one or more processors are further configured to cause the network node to:
transmit, to the UE, an acknowledgement message, wherein communicating the second set of one or more messages according to the updated minimum time offset is associated with transmitting the acknowledgement message.

19. The apparatus of claim 18, wherein the acknowledgement message includes a toggled new data indicator associated with a same hybrid automatic repeat request process as at least one of the first set of one or more messages or the second set of one or more messages.

20. The apparatus of claim 18, wherein the acknowledgement message includes an acknowledgement that the first set of one or more messages was received by the network node.

21. A method of wireless communication performed by a user equipment (UE), comprising:
communicating, with a network node, a first set of one or more messages according to a minimum time offset between a control message and a data message;
transmitting a communication status report in association with one or more conditions, associated with communications at the UE, being satisfied; and
communicating, with the network node, a second set of one or more messages according to an updated minimum time offset in association with transmitting the communication status report.

22. The method of claim 21, further comprising:
communicating a third set of one or more messages according to the minimum time offset.

23. The method of claim 22, further comprising:
transmitting a buffer status report that indicates an empty buffer of the UE, wherein communicating the third set of one or more messages is associated with transmitting the buffer status report.

24. The method of claim 22, further comprising:
transmitting an end of burst indication, wherein communicating the third set of one or more messages is associated with transmitting the end of burst indication.

25. The method of claim 22, further comprising:
discarding a set of one or more packet data units in accordance with an expiration of a discard timer associated with the communication status report, wherein communicating the third set of one or more messages according to the minimum time offset is associated with discarding the set of one or more packet data units.

26. The method of claim 21, wherein:
the communication status report includes a scheduling request configuration that is associated with a logical channel group, and
the updated minimum time offset corresponds to the scheduling request configuration.

27. A method of wireless communication performed by a network node, comprising:
communicating, with a user equipment (UE), a first set of one or more messages according to a minimum time offset between a control message and a data message;
receiving a communication status report indicating that one or more conditions, associated with communications at the UE, are satisfied; and
communicating, with the UE, a second set of one or more messages according to an updated minimum time offset in association with transmitting the communication status report.

28. The method of claim 27, wherein communicating the second set of one or more messages according to the updated minimum time offset comprises:
transmitting an additional control message that schedules resources for an uplink data message; and
receiving, according to the updated minimum time offset, the uplink data message.

29. The method of claim 27, further comprising:
communicating, with the UE, one or more messages according to a frequency resource configuration; and
communicating, with the UE, one or more messages according to an updated frequency resource configuration in association with receiving the communication status report.

30. The method of claim 27, further comprising:
communicating, with the UE, one or more messages according to a control monitoring periodicity; and
communicating, with the UE, one or more messages according to an updated control monitoring periodicity in association with receiving the communication status report.
